(19) United States
(12) Patent Application Publication
(10) Pub. No.: US 2009/0259528 A1
(43) Pub. Date: Oct. 15, 2009

(54) METHOD AND DEVICE FOR ENSURING DATA PRIVACY IN OFFBOARD TOLL COLLECTION

(75) Inventors: Georg Ebersberger, Duesseldorf (DE); Bernd Guenther, Bonn (DE)

Correspondence Address: DARBY & DARBY P.C., P.O. BOX 770, Church Street Station, New York, NY, 10008-0770, US

(73) Assignee: DEUTSCHE TELEKOM AG, Bonn (DE)

(21) Appl. No.: 12/306,783

(22) PCT Filed: Jun. 21, 2007
(86) PCT No.: PCT/DE2007/001098

§ 371 Date: Dec. 29, 2008

(30) Foreign Application Priority Data
Jun. 27, 2006 (DE) 10 2006 029 383.5

(51) Int. Cl. G07B 15/00

(52) U.S. Cl. 705/13; 705/417

(57) ABSTRACT

A method for determining toll routes, using a filter unit and a vehicle onboard unit onboard unit in communication with one another, the filter unit having map material so that toll routes are determinable on the basis of a position data, includes transmitting, by the onboard unit, the position data to the filter unit so that the position data is checkable for toll relevance without revealing an identity of the onboard unit. The transmitted position data is checked for toll relevance. Toll collection data is transmitted to the onboard unit for charge calculation and billing. The toll routes are stored by the onboard unit. The toll routes are transmitted to a toll collection point for the charge calculation.

### CLAIM OF PRIORITY

This application is a U.S. National Phase application under 35 U.S.C. § 371 of International Application No. PCT/DE2007/001098, filed Jun. 21, 2007 and claims benefit to German Patent Application No. DE 10 2006 029 383.5, filed on Jun. 27, 2006. The International Application was published in German on Jan. 3, 2008 as WO/2008/000227 A1 under PCT Article 21(2).

### FIELD

The invention relates to a method and devices for ensuring data privacy in determining toll routes, and in particular to a server and an onboard unit (OBU) which communicate with each other, the server having map material so that toll routes are determinable on the basis of anonymized position data.

### BACKGROUND

The collection of tolls from trucks in Germany is largely carried out using the OBU built into the truck. The OBU calculates the distance traveled on toll routes, and from this distance the toll, on the basis of cyclically ascertained position values with the aid of the GPS system (GPS positions). To ensure that charges are calculated only for trips on toll routes, the OBU validates the ascertained positions against an internally stored digital map having the toll route segments; i.e., charges are calculated only when the OBU is located on toll routes. Since tariff models based on individual times of day are possible in principle, these tariff models are also stored in the OBU, to a certain extent in generalized form. The toll route segments traveled are then sent together with an identification of the toll payer (toll ID) to the toll collection points for billing purposes. In OBU Version 2 (OBU2) and later, the maps stored in the OBU may be updated “over the air”, i.e. by radio, and the toll route network changed thereby. Due to this procedure and the volumes of data which must be stored internally and continuously updated by the OBU, the OBU and its operation represent a complex, expensive and inflexible system.

As an alternative to the method described above and implemented in Germany, there is the concept of offboard toll collection. In this case, a digital map is not stored in the OBU, but instead only positions are ascertained, stored and forwarded together with the toll ID to an external server for the purpose of evaluation and toll collection, typically via GSM or GPRS, UMTS, WLAN or other wireless communication methods. On the external server, the positions for determining the toll route segments traveled, which are recorded in the OBU, are used to carry out a comparison with the digital map stored on the server and containing the toll routes. The toll route segments are then forwarded to the toll collection points for billing purposes. In this case, the OBU must only collect and forward position data, but not perform a comparison with a map. In addition, neither a map nor the tariff model needs to be stored and updated on the OBU. This makes the OBU simple, cheap and stable in terms of software technology. In this method, the problem from the perspective of data privacy concerns the transmission and storage of all positions, and not just the ones on toll route segments, if such positions are associated with the toll ID. The route of the OBU, and thus also the vehicle, could also be tracked thereby on non-toll routes.

### SUMMARY

In an embodiment, the present invention provides a method for determining toll routes, using a filter unit and a vehicle onboard unit in communication with one another, the filter unit having map material so that toll routes are determinable on the basis of a position data. The method includes the following steps: transmitting, by the onboard unit, the position data to the filter unit, so that the position data is checkable for toll relevance without revealing an identity of the onboard unit; checking the transmitted position data for toll relevance; transmitting toll collection data to the onboard unit for charge calculation and billing; storing the toll routes by the onboard unit; and transmitting the toll routes to a toll collection point for the charge calculation.

### BRIEF DESCRIPTION OF THE DRAWINGS

FIG. 1 illustrates a system in accordance with an embodiment of the present invention.

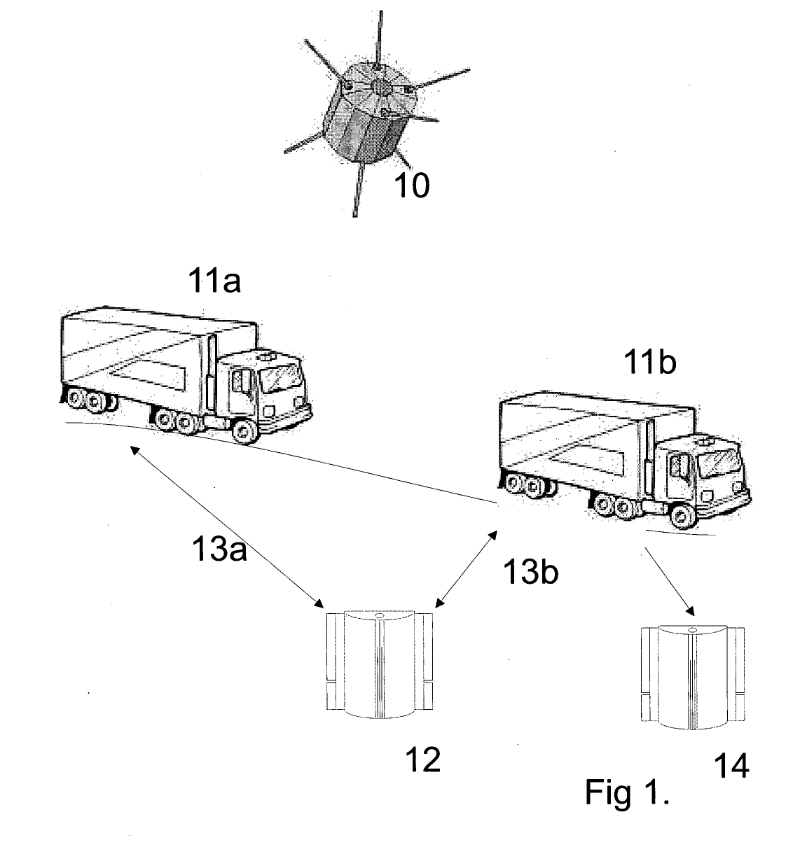

### DETAILED DESCRIPTION

By way of overview and introduction, the present invention provides an improved method for ensuring data privacy in offboard toll collection via a corresponding OBU.

In an embodiment, the present invention provides a server system for determining toll routes. The system includes a filter unit including a memory having map material stored therein, the filter unit configured to determine toll routes on the basis of position data, a vehicle onboard unit in communication with the filter unit across a network, and configured to send position data to the filter unit, and the filter unit further including a processing unit configured to check the position data for toll relevance by accessing the memory, free of an identity of the onboard unit, wherein the filter unit is further configured to transmit toll collection data to the onboard unit for charge calculation and billing if a toll relevance exists.

In another embodiment, the present invention provides, in combination, a vehicle onboard unit and a filter unit configured to determine toll routes from position data transmitted to the filter unit by the onboard unit. The combination includes a memory in the filter unit containing map material so that toll routes can be determined on the basis of the position data, a transmission unit in the onboard unit configured to send position data of at least one subroute to the filter unit, wherein the position data is checkable for toll relevance free of an identity of the onboard unit, a receiving unit in the onboard unit configured to receive toll collection data from the filter unit for charge calculation and billing operations, a memory in the onboard unit configured to store the at least one subroute so as to form the entire route, and a transmission unit in the onboard unit configured to transmit the entire route to a toll collection point at an end of a trip.

An embodiment of the present invention relates to a method in which the offboard toll collection method may be carried out in such a way that, while retaining the advantages of this method, the data privacy requirements with regard to anonymity and storage of position data are taken into account.

The method includes “filtering the position data for toll relevance” and “transmitting the toll collection data,” which are separated for charge calculation and billing purposes in such a way that the upstream filtering process is carried out without any knowledge of the toll payer's identity. In doing this, the OBU regularly transmits the position information of subroutes (e.g., every 50 or 100 kilometers or every 5 minutes), without any indication of the sender's identity, to a central filter unit, which uses knowledge of the complete route network and up-to-date tariff models to determine the actual toll route segments. The information on these toll route segments is sent back to the OBU. Once the OBU has confirmed correct receipt, all data on the transaction which is stored centrally in the filtering unit is deleted.

The OBU then stores the toll segments until the entire route is transmitted to the toll collection point. The entire route is never sent to the central filter unit, and the latter also does not gain any knowledge of the toll ID. The substeps of filtering for toll relevance and transmitting the toll data run completely asynchronously via different connections which are set up separately for each data transmission. Since a different connection having unpredictable IP addresses is used for each transmission from the OBU to the external entities, conclusions as to one of the two processing entities may not be drawn from the other processing entity. In particular, neither the entire route—provided that the latter contains non-toll routes—may be assembled, nor a reference to the toll payer established, at any point in the system.

Because the actual toll segments are sent back to the OBU, the data communication volume is only slightly greater than that of a method which avoids this step. Moreover, different embodiments enable this aspect to be optimized. For example, the following information elements may be sent to the OBU after filtering, either as alternatives or in combination:

Road segment IDs

Road class categories with distance

Evaluated tariff data records for the subroute

According to an embodiment of the method described above, the total route traveled is no longer ascertainable for the external server and/or assigned to a toll ID and therefore to a toll payer. Data privacy is thus again ensured.

The principle of anonymized preprocessing of sensitive data for evaluating relevance and downstream further processing, revealing the user identity, the identity and user data being combined only in the end device, is not limited to the offboard toll application.

In the preferred embodiment, truck 11a, 11b has an onboard unit which receives GPS information from a satellite 10 for the purpose of determining the positions. These positions are sent from the OBU in the truck to filter unit 12 at regular intervals. A first communication 13a may thus take place at a point a, while a second communication 13b is carried out by the truck at a point b at a later time. As described above, only the positions, and no identifying information, is transmitted, so that it is not possible to uniquely identify the OBU, and therefore the truck. No identities whatsoever are transmitted, and only the communication address (IP address) is the reference point. However, even this address is redetermined fore each individual communication connection, since the OBU is assigned a dynamic IP address by the network during connection setup. In the end, after the vehicle has collected all data necessary to calculate the toll route, this data is sent to a billing server 14, which then calculates the toll charges. Due to the fact that only information from which it may be concluded whether the truck is or is not located on a toll route is transmitted from filter unit 12 to truck 11a, 11b, the communication may take place anonymously. This anonymity is lifted only at the end of the trip, when the onboard unit sends the entire route to which the toll applies to toll billing server 14. Only then is the vehicle's identity revealed.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

### LIST OF REFERENCE NUMERALS

10 GPS satellite
11a Truck having an OBU at position a
11b Truck having an OBU at position b
12 Filter unit including car material
13a Communication between filter unit and truck at position a
13b Communication between filter unit and truck at position b
14 Toll collection point for receiving the toll route for toll collection purposes

1-15. (canceled)

16. A method for determining toll routes, using a filter unit and a vehicle onboard unit onboard unit in communication with one another, the filter unit having map material so that toll routes are determinable on the basis of a position data, the method comprising the following steps:
transmitting, by the onboard unit, the position data to the filter unit so that the position data is checkable for toll relevance without revealing an identity of the onboard unit;
checking the transmitted position data for toll relevance;
transmitting toll collection data to the onboard unit for charge calculation and billing;
storing the toll routes by the onboard unit; and
transmitting the toll routes to a toll collection point for the charge calculation.

17. The method according to claim 16, wherein the transmitting of position data by the onboard unit includes sending, by the onboard unit, position information of subroutes to the filter unit free of any indication of an identity of the onboard unit, and further comprising the step of determining, by the filter unit, actual toll route segments using knowledge of a complete route network and up-to-date tariff models.

18. The method according to claim 16, further including the step of deleting from the filter unit all centrally stored data relating to a current transaction after the onboard unit has confirmed a correct receipt of the toll collection data.

19. The method according to claim 16, wherein the step of checking the transmitted position data and the step of transmitting the toll collection data run asynchronously via different connections, at least one of the checking the transmitted position data step and the transmitting the toll collection data step being performed at an end of a trip.

20. The method according to claim 16, further comprising the step of utilizing a different connection having unpredictable network addresses for each transmission from the onboard unit to the filter unit, so that conclusions as to a first of two processing entities may not be drawn from a second of the two processing entities.

21. The method according to claim 16, wherein the step of transmitting toll collection data includes sending, from the filter unit, at least one of road segment IDs, road class categories including distance, and evaluated tariff data records.

22. A server system for determining toll routes, comprising:
a filter unit including a memory having map material stored therein and a processing unit configured to check position data for toll relevance by accessing the memory, free of an identity of the onboard unit, the filter unit being configured to transmit toll collection data to the onboard unit for charge calculation and billing if a toll relevance exists, the filter unit being configured to determine toll routes on a basis of the position data; and
a vehicle onboard unit onboard unit in communication with the filter unit across a network, and configured to send the position data to the filter unit.

23. The server system according to claim 22, wherein the processing unit is configured to delete all centrally stored data relating to a current transaction from the memory after the onboard unit has confirmed a correct receipt of the toll collection data.

24. The server system according claim 22, wherein the processing unit is configured to determine a subroute even if position data of an entire route traveled, or information identifying a toll payer, the onboard unit, or the vehicle, is not sent.

25. In combination, a vehicle onboard unit and a filter unit configured to determine toll routes from position data transmitted to the filter unit by the onboard unit, comprising:
a memory in the filter unit containing map material so that toll routes can be determined on the basis of the position data;
a transmission unit in the onboard unit configured to send position data of at least one subroute to the filter unit, wherein the position data is checkable for toll relevance free of an identity of the onboard unit;
a receiving unit in the onboard unit configured to receive toll collection data from the filter unit for charge calculation and billing operations;
a memory in the onboard unit configured to store the at least one subroute so as to form the entire route; and
a transmission unit in the onboard unit configured to transmit the entire route to a toll collection point at an end of a trip.

26. The onboard unit according to claim 25, wherein:
the transmission unit is configured to send the position data of the at least one subroute at regular intervals free of the identity of the onboard unit; and
the filter unit is configured to determine actual toll route segments using knowledge of a complete route network and up-to-date tariff models.

27. The onboard unit according to claim 25, wherein the transmission unit is configured to at least one of not send the entire route to the filter unit and not transmit the toll ID.

28. The onboard unit according to claim 25, wherein the checking for toll relevance and transmitting the toll data at the end of the trip is done completely asynchronously via separate connections.

29. The onboard unit according to claim 25, wherein the transmission unit is configured to use a different connection having unpredictable network addresses for each transmission to the filter unit, so that conclusions as to a first of two processing entities may not be drawn from a second of the processing entities.

30. The onboard unit according to claim 25, wherein, at least one of the position data and toll collection data includes at least one of road segment IDs, road class categories including a length, and evaluated tariff data records for the at least one subroute.
